(19) United States
(12) Patent Application Publication
(10) Pub. No.: US 2014/0186711 A1
(43) Pub. Date: Jul. 3, 2014

(54) ALKALINE SECONDARY BATTERY

(71) Applicants: Jun Nunome, Kyoto (JP); Fumio Kato, Osaka (JP); Machiko Tsukiji, Osaka (JP)

(72) Inventors: Jun Nunome, Kyoto (JP); Fumio Kato, Osaka (JP); Machiko Tsukiji, Osaka (JP)

(21) Appl. No.: 13/580,295

(22) PCT Filed: Dec. 5, 2011
(86) PCT No.: PCT/JP2011/006799

§ 371 Date: Aug. 21, 2012

(30) Foreign Application Priority Data
Feb. 22, 2011 (JP) 2011-035652

(51) Int. Cl. H01M 4/42; H01M 10/24

(52) U.S. Cl. CPC H01M 4/42; H01M 10/24
USPC 429/224; 429/229; 252/512

(57) ABSTRACT

In an alkaline secondary battery including a gelled negative electrode containing zinc alloy powder, an aspect ratio of a particle of the zinc alloy powder is within a range of 2.0-2.4, and the zinc alloy contains 150-350 ppm of bismuth, and 600-1500 ppm of indium.

### TECHNICAL FIELD

The present invention relates to alkaline secondary batteries having high resistance to electrolyte leakage.

### BACKGROUND ART

In recent years, with an increase in environmental awareness, a need exists for charge/discharge use of alkaline dry batteries which are primary batteries. Used alkaline dry batteries can be reused by being charged; however, in some cases, charge/discharge use of alkaline dry batteries designed as primary batteries and remaining unchanged do not provide sufficient performance which should be achieved by secondary batteries.

For example, when alkaline dry batteries used as primary batteries are used as secondary batteries, this cannot provide sufficient cycle characteristics.

To address this problem, PATENT DOCUMENT 1 describes an alkaline secondary battery in which a reduction in self-discharge and improvement in cycle characteristics are achieved by using a negative electrode obtained by adding a composite zinc oxide of zinc, indium, bismuth, etc., to a zinc alloy containing indium, bismuth, etc.

In contrast, when an alkaline dry battery which is a primary battery is used as a secondary battery, improvement in the performance of the alkaline dry battery itself helps improve the performance of the secondary battery.

For example, PATENT DOCUMENT 2 describes a technique in which in order to enhance discharge characteristics of an alkaline dry battery, the contents of metals, such as aluminum and indium, in a zinc alloy, and the content of zinc alloy particles having a predetermined particle size are defined in corresponding predetermined ranges.

Furthermore, PATENT DOCUMENT 3 describes a technique in which in order to enhance fluidity of zinc alloy powder, the aspect ratio of a zinc alloy particle is defined in a predetermined range.

### CITATION LIST

### Patent Documents

PATENT DOCUMENT 1: Japanese Patent Publication No. H11-176467
PATENT DOCUMENT 2: Japanese Patent Publication No. 2007-128707
PATENT DOCUMENT 3: Japanese Patent Publication No. H09-235636

### SUMMARY OF THE INVENTION

### Technical Problem

Currently, in order to balance reduction of gas generation and discharge performance, in an alkaline dry battery which is a primary battery, for example, the contents of metals, such as aluminum and indium, in a zinc alloy, the aspect ratio of a zinc particle, and the proportion of zinc alloy particles having a predetermined particle size are defined.

For example, a zinc alloy generally used as a negative electrode material of an alkaline dry battery typically has a bismuth content less than or equal to 100 ppm, and an indium content less than or equal to 400 ppm; the aspect ratio of a particle of the zinc alloy is typically about 1.8; and the proportion of particles of the zinc alloy having a particle size less than or equal to 75 μm is typically 20-40% by mass.

However, the inventors' study showed that when an alkaline dry battery using such zinc particles has been charged/discharged, the amount of gas generation after a charge/discharge cycle may become so large that electrolyte leakage occurs.

In order to prevent electrolyte leakage from such an alkaline secondary battery after a charge/discharge cycle, the alkaline secondary battery may be configured such that even with generation of a large amount of gas after charge/discharge, an increase in battery internal pressure is reduced, e.g., by increasing the amount of space in the alkaline dry battery, and thus, electrolyte leakage is less likely to occur. However, the above configuration of the alkaline secondary battery remarkably reduces discharge performance, and thus, it is difficult to use the alkaline secondary battery with the above configuration as a practical product.

Conventionally, no consideration has been given to electrolyte leakage from such an alkaline secondary battery after a charge/discharge cycle. In view of the foregoing, the present invention has been achieved. A principal object of the present invention is to provide an alkaline secondary battery configured to reduce electrolyte leakage after a charge/discharge cycle while maintaining discharge performance.

### Solution to the Problem

An alkaline battery according to the present invention includes: a gelled negative electrode containing zinc alloy powder. An aspect ratio of a particle of the zinc alloy powder is within a range of 2.0-2.4, and the zinc alloy contains 150-350 ppm of bismuth, and 600-1500 ppm of indium.

In one preferred embodiment, a mass ratio of bismuth to indium in the zinc alloy may be within a range of 1:3-1:6.

The zinc alloy powder preferably contains particles having a particle size of 75 μm or less in a proportion of 5-18% by mass.

### Advantages of the Invention

According to the present invention, when the shape of particles of a zinc alloy and the composition of the zinc alloy are both optimized, a change in the shape of zinc particles and segregation of added elements are less likely to occur even with repetitions of charge/discharge, thereby reducing gas generation from zinc. This can provide an alkaline secondary battery configured to reduce electrolyte leakage after a charge/discharge cycle while maintaining discharge performance.

### BRIEF DESCRIPTION OF THE DRAWINGS

FIG. 1 is a partial cross-sectional view illustrating the structure of an alkaline secondary battery according to an embodiment of the present invention.

### DESCRIPTION OF EMBODIMENTS

The inventors of the present invention studied the reason why, when an alkaline dry battery using zinc alloy powder as a negative electrode is charged/discharged, generation of a large amount of gas after a charge/discharge cycle causes electrolyte leakage, and the inventors' study showed the following finding.

When an alkaline dry battery using zinc alloy powder as a negative electrode is discharged, zinc alloy particles are dissolved to form a zinc oxide, and when the alkaline dry battery is next charged, zinc metal is deposited. However, in this case, the zinc metal after charge is not precisely identical with the original zinc alloy powder. Specifically, the shape of the zinc metal changes, and the surface area thereof tends to increase. As a result, elements, such as bismuth and indium, added into the original zinc alloy powder to improve anti-corrosive performance are segregated out of the zinc crystal surface due to repeated charges/discharges.

In particular, indium significantly acting to raise the hydrogen overvoltage moves to a positive electrode with a repetition of charge/discharge, and thus, indium hardly exists in a portion of the negative electrode.

It is seen from such a phenomenon that as the battery is repeatedly charged/discharged, the anti-corrosive performance of the zinc alloy decreases, and thus, a large amount of hydrogen gas is generated, thereby causing electrolyte leakage.

Based on the above finding, an attempt was made to simply increase the amount of elements, such as bismuth and indium, added in order to improve anti-corrosive performance of the zinc alloy; however, the added elements move out of zinc crystals with charge/discharge, and thus, the attempt was not very effective.

The change in the shape of a zinc metal was focused on, and attempts were made to allow the shape of a zinc particle to be closer to a spherical shape, and to oppositely increase the flatness of a zinc particle; however, these attempts alone were not very effective.

Furthermore, an attempt was made to simply add an organic or inorganic compound which can be expected to reduce corrosion of a zinc negative electrode in an alkaline dry battery being a primary battery; however, this attempt alone was not effective enough. Addition of an excessive amount of materials other than active materials resulted in a significant decrease in discharge performance.

An embodiment of the present invention will be described hereinafter in detail with reference to the drawing. The present invention is not limited to the following embodiment. Various modifications can be made to the embodiment without deviating from the scope of the present invention. The embodiment can be combined with other embodiments.

A gelled negative electrode of an alkaline secondary battery of the present invention contains zinc alloy powder, and zinc in the zinc alloy powder acts as a negative electrode active material. The aspect ratio of any zinc alloy particle, i.e., the ratio of the length of the long side of the zinc alloy particle to the length of the short side thereof, is in the range of 2.0-2.4.

In a process for producing zinc particles, a so-called atomization process is generally used in which molten zinc is sprayed with high pressure gas so as to be pulverized. In this case, examples of methods for adjusting the aspect ratio of the zinc alloy particle include adjusting the oxygen concentration in the sprayed gas or a particle cooler, adjusting the spraying pressure and the nozzle shape, and spraying the molten zinc onto, e.g., a plate.

In the present invention, the aspect ratio is controlled by adjusting the oxygen concentration in a particle cooler, the spraying nozzle shape, and the spraying pressure. The aspect ratio herein denotes a value obtained by determining the major diameter of a zinc alloy powder (the largest diameter of the powder) and the minor diameter thereof (the diameter of the powder orthogonal to the largest diameter thereof) and dividing the major diameter by the minor diameter.

When the aspect ratio of the zinc particle is lower than 2.0, the particle is approximately spherical, and the reactive surface area of the particle in an early stage becomes insufficient. Not only performance is degraded due to insufficient contact among particles, but also reaction in the negative electrode becomes nonuniform due to insufficient contact among particles also during charge, and the change in the shape of the zinc particle proceeds.

When the aspect ratio of the zinc particle is higher than 2.4, and the zinc particle has a large specific surface area, extraction of an added element, such as indium, from the interior of the zinc particle becomes significant, and the amounts of bismuth and indium remaining in the zinc particle after charge/discharge decrease.

The zinc alloy powder includes a zinc alloy containing 150 ppm to 350 ppm, both inclusive, of bismuth, and 600 pm to 1500 ppm, both inclusive, of indium which are alloy elements in an initial state.

When the bismuth and indium contents in the zinc alloy are too low, not only the anti-corrosive performance of zinc from the early stage becomes insufficient, but also after charge/discharge, the anti-corrosive performance becomes insufficient, and thus, no sufficient effect is produced. When the contents are too high, discharge performance is degraded, and the charge/discharge performance of the battery is degraded due to an increase in polarization resistance during charge.

The mass ratio of bismuth being an alloy element to indium being also an alloy element (bismuth:indium) is preferably in the range of 1:3 to 1:6. The reason for this is that when the ratio between bismuth and indium which have been eluted out of the zinc particle by discharge is specific, bismuth and indium tend to return to the interior of the deposited zinc.

The proportion of particles of the zinc alloy powder having a particle size less than or equal to 75 μm is preferably in the range of 5-18% by mass. When the proportion of the fine zinc alloy powder particles is in the above range, the shape and surface area of redeposited zinc after charge/discharge are optimized, and thus, the gas generation rate decreases.

The zinc alloy powder may contain an alloy element other than bismuth and indium. Examples of the alloy element include aluminum, calcium, and lead. The zinc alloy powder preferably contains 10-30 ppm of lead, because gas is generated at the lowest rate.

The positive electrode preferably contains 9.1 g or more of manganese dioxide, and the negative electrode preferably contains 3.6 g or more of a zinc alloy and 1.75 ml or more of an electrolyte solution. When the amounts of manganese dioxide and the zinc alloy which are active materials of batteries are smaller than the above amounts, the battery performance (discharge capacity) in the early stage and after charge/discharge is insufficient, and thus, such a battery is less practical.

Furthermore, when the amount of the electrolyte solution is small, not only discharge polarization increases with an increase in the battery internal resistance, but also polarization during charge increases, and under practical charge conditions, the battery is not charged fully. In addition, the condition of zinc tends to be locally changed as described above, and electrolyte leakage also tends to occur.

Typically, the larger the amounts of all of manganese dioxide, zinc, and an electrolyte solution are, the higher the initial discharge performance is, and the initial performance tends to be maintained also after charge/discharge; however, since the amount of space in such a battery is reduced, gas generated after charge/discharge is more likely to cause electrolyte leakage, in particular, from such an alkaline secondary battery.

The particle size of the zinc alloy powder of the present invention herein denotes the particle size determined by classifying the zinc alloy powder using a sieve. Specifically, the above “particle having a particle size less than or equal to 75 μm” denotes a particle which can pass through a standard sieve having 75 μm openings.

As all of particles of the zinc alloy powder, zinc alloy powder particles which can pass through a sieve having 425 μm openings are preferably used.

The aspect ratio of a zinc alloy powder particle can be measured by the following method. Zinc particles are classified through three types of sieves, i.e., a 48 mesh sieve, a 100 mesh sieve, and a 200 mesh sieve, 48-100 mesh particles and 100-200 mesh particles were observed by using an electron microscope. The major diameters of ten of the 48-100 mesh zinc alloy powder particles and ten of the 100-200 mesh zinc alloy powder particles (the largest diameters of the powder particles) and the minor diameters thereof (the diameters of the powder particles orthogonal to the largest diameters thereof) are determined based on taken pictures (two-dimensional images), values obtained by dividing the major diameters by the corresponding minor diameters are defined as the aspect ratios of the 48-100 mesh particles and the 100-200 mesh particles, and the average of all of the obtained aspect ratios of the 48-100 mesh particles and the 100-200 mesh particles is the aspect ratio of a zinc alloy powder particle of the present invention.

The negative electrode of the alkaline battery of the present invention is a gelled negative electrode, and contains a gelling agent, and an alkaline electrolyte solution in addition to the zinc alloy powder. The gelling agent is not particularly limited, and a gelling agent used for known alkaline batteries, e.g., various polymeric gelling agents, such as carboxymethylcellulose, polyacrylic acid, and sodium polyacrylate, can be used. The proportion of the content of the gelling agent in the gelled negative electrode to the content of the zinc alloy therein is preferably, for example, 1.0-2.5% by mass.

The gelled negative electrode may contain other additives. For example, powder of indium oxide, indium hydroxide, and aluminum hydroxide can be used while being mixed or dissolved during preparation of the gelled negative electrode. For example, indium hydroxide is preferably added in a proportion of 0.02-0.1% relative to the zinc alloy. Furthermore, an organic surfactant may be added.

A solution which is similar to an alkaline electrolyte solution used for alkaline batteries including a known gelled negative electrode (e.g., an aqueous solution of a hydroxide of an alkali metal, such as potassium hydroxide and sodium hydroxide) can be used as the above alkaline electrolyte solution. The alkali concentration in the alkaline electrolyte solution may be also approximately identical with that of a conventionally known alkaline battery, and is preferably, e.g., 33-39% by mass. The alkaline electrolyte solution may contain a zinc oxide, and the content of the zinc oxide is preferably 2-10% by mass. The proportion of the alkaline electrolyte solution to the zinc alloy in the gelled negative electrode is preferably 40-58% by mass, and is more preferably 48-54% by mass.

The gelled negative electrode can be prepared, e.g., by a method in which zinc alloy powder is mixed into an alkaline electrolyte solution previously gelled using the above gelling agent. When the indium compound is used, the indium compound may be previously mixed with zinc alloy powder, and then, the resulting mixture may be mixed with a gelled alkaline electrolyte solution. Alternatively, the indium compound may be added when the zinc alloy powder and the gelled alkaline electrolyte solution are mixed together. The gelled negative electrode may be prepared by any other methods.

A major feature of the alkaline secondary battery of the present invention is that the alkaline secondary battery includes a negative electrode containing the above zinc alloy. The other structures are less specifically limited, and structures used for known alkaline batteries (including alkaline primary batteries) can be used.

Manganese dioxide is used as a principal positive electrode active material, and nickel oxyhydroxide, silver oxide, silver nickel oxide, etc., can be used. Manganese dioxide may be electrolytic manganese dioxide, natural manganese dioxide, or chemically synthesized manganese dioxide. Polyethylene, etc., may be added, as a binder, into a positive electrode, and metatitanic acid or titanium dioxide may be mixed thereinto as an additive. The materials may be added to the extent that the amount of the principal active material does not significantly decrease, and the amount of the materials added may be, for example, 0.1-1% by mass.

A separator may be a nonwoven fabric of vinylon or rayon used for conventional alkaline dry batteries, and alternatively, a microporous film of cellophane, a graphite polymer film, polyolefine, etc., may be used.

Batteries which can exhibit the most typical effect of the present invention is AA alkaline dry batteries, the mass of manganese dioxide contained in such a battery is 9.4 g, the mass of a zinc alloy is 3.8 g, and the total mass of all of electrolyte solutions is 1.75 ml. Furthermore, when the battery contains 9.1 g or more of manganese dioxide, 3.6 g or more of a zinc alloy, and 1.75 ml of electrolyte solutions, the battery can have high discharge performance and excellent leakage resistance after charge/discharge, and provide a good balance between the discharge performance and the leakage resistance.

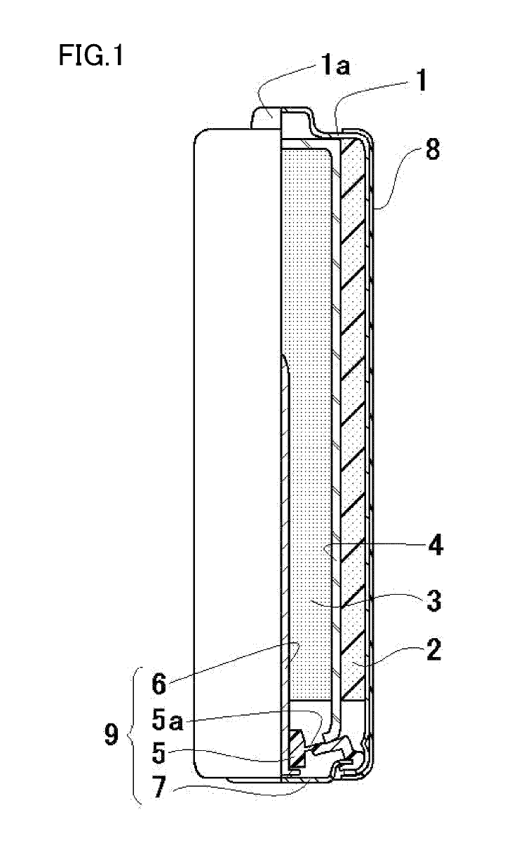

An embodiment of the present invention will be described hereinafter with reference to the drawing. FIG. 1 is a partial cross-sectional view schematically illustrating an alkaline secondary battery according to the embodiment of the present invention.

A hollow cylindrical positive electrode 2 containing manganese dioxide is housed in a battery case 1 also serving as a positive electrode terminal 1a to be in contact with the inner surface of the battery case 1. A gelled negative electrode 3 containing a zinc alloy is disposed in a hollow portion of the positive electrode 2 while a separator 4 made of a cylindrical porous film having a closed bottom is interposed between the negative electrode 3 and the positive electrode 2. The positive electrode 2, the gelled negative electrode 3, and the separator 4 contain an alkaline electrolyte solution made of an aqueous alkaline solution. After power-generating elements, such as the positive electrode 2 and the gelled negative electrode 3, are housed in the battery case 1, an opening of the battery case 1 is sealed via a sealing unit 9 integrally including a negative electrode terminal 7 electrically connected to a nail-shaped negative electrode current collector 6, and a gasket 5 made of resin and having a thin portion 5a serving as a safety valve. The outer surface of the battery case 1 is coated with an exterior label 8.

### EXAMPLES

The present invention will be described hereinafter in detail with reference to examples.

### (1) Production of Battery

An aqueous solution in which the content of potassium hydroxide and the content of zinc oxide are 38% by mass and 5% by mass, respectively, was prepared as an alkaline electrolyte solution.

A gelled alkaline electrolyte solution was prepared by adding 1.0% by mass of polyacrylic acid and 1.0% by mass of sodium polyacrylate to the above alkaline electrolyte solution. Indium hydroxide was added to the gelled alkaline electrolyte solution in a proportion of 0.05% relative to a zinc alloy. The following zinc alloy powder was prepared: the aspect ratio of a particle of the prepared zinc alloy powder is 2.0; the zinc alloy powder includes a zinc alloy containing 50 ppm of aluminum, 250 ppm of bismuth, and 1000 ppm of indium; and the proportion of particles of the zinc alloy powder having a particle size less than or equal to 75 μm is 12% by mass.

The gelled alkaline electrolyte solution and the zinc alloy powder were mixed in a mass ratio of 100:185, thereby preparing a gelled negative electrode 3.

Electrolytic manganese dioxide was used as an active material of a positive electrode 2, and the positive electrode 2 obtained by mixing the manganese dioxide and graphite in a mass ratio of 94:6 and shaped in a ring was used. Battery 1 (AA alkaline secondary battery) having a structure illustrated in FIG. 1 was fabricated by using the positive electrode 2, the gelled negative electrode 3, and the alkaline electrolyte solution.

The mass of manganese dioxide contained in the battery of this example was 9.4 g, the mass of the zinc alloy contained therein was 3.8 g, and the total mass of all of electrolyte solutions contained therein was 1.75 ml.

### (2) Charge-Discharge Test

Battery 1 and all below-described batteries which were aged for 3 days at 40° C. after being fabricated were evaluated. The evaluation was made by measuring the gas generation rate after a charge-discharge test in the method described below.

The charge-discharge test was conducted as follows. Each of the batteries was continuously discharged at 100 mA until the voltage of the battery reaches 1.0 V; and after a one-hour pause was taken, the battery was charged at a controlled constant voltage of 1.9 V to a maximum current value of 250 mA. When the current value reached 25 mA, the charge terminated, and after the termination of the charge, a one-hour pause was taken. The above process corresponds to one cycle. This charge/discharge cycle was performed ten times. The battery was charged and discharged in an environment of 20° C.

After the charge/discharge cycle was performed ten times, three batteries in a charged state were each measured by cutting away a protrusion of a positive electrode terminal, and substituting and collecting generated gas in the battery using a glass container. The gas exiting from the battery can be collected in the glass container by filling the interior of the glass container with liquid paraffin and immersing the battery in the liquid paraffin, and a graduated container was used to allow measurement of the volume of the gas.

The batteries were placed in this container, and were left stand for 14 hours; and then, a measurement of the increase in the amount of gas from each of the batteries in 5 days in an atmosphere of 25° C. was started. The average daily amount of generated gas for 5 days is expressed in ml/day, and the average of the values of the three batteries was determined.

When the gas generation rate after the charge-discharge test is less than or equal to 0.25 ml/day, electrolyte leakage is less likely to occur during or after use of the battery.

### (3) Aspect Ratio of Zinc Particle

Batteries 2-7 similar to Battery 1 were produced except that the aspect ratio of a zinc particle in each of Batteries 2-7 is the aspect ratio illustrated in Table 1. Table 1 illustrates results of charge-discharge tests.

TABLE 1

| | | GAS GENERATION |
|---|---|---|
| | ASPECT RATIO | RATE AFTER |
| | OF ZINC | CHARGE/DISCHARGE TEST |
| | ALLOY PARTICLE | (ml/day) |
| BATTERY 1 | 1.6 | 0.35 |
| BATTERY 2 | 2.0 | 0.21 |
| BATTERY 3 | 2.0 | 0.15 |
| BATTERY 4 | 2.2 | 0.12 |
| BATTERY 5 | 2.2 | 0.13 |
| BATTERY 6 | 2.4 | 0.20 |
| BATTERY 7 | 2.7 | 0.45 |

As illustrated in Table 1, it was found that the aspect ratio of a zinc particle is related to the gas generation rate after charge/discharge, and that when the aspect ratio is 2.0-2.4, the gas generation rate is low. In contrast, the gas generation rate of Battery 1 in which the aspect ratio is less than 2.0 is high. The gas generation rate of Battery 7 in which the aspect ratio is too high, such as 2.7, is also high.

### (4) Bismuth Concentration in Zinc Alloy

Next, Batteries 8-22 were produced under conditions similar to those of Battery 1 except that as illustrated in Table 2, when the aspect ratio of a zinc particle ranges from 2.0 to 2.4, the bismuth concentration in the zinc alloy was varied. Table 2 illustrates results of charge-discharge tests.

TABLE 2

| | | | | INDIUM | GAS GENERATION |
|---|---|---|---|---|---|
| | | BISMUTH | INDIUM | CONCENTRATION/ | RATE AFTER |
| | ASPECT RATIO | CONCENTRATION | CONCENTRATION | BISMUTH | CHARGE/ |
| | OF ZINC ALLOY | IN ZINC ALLOY | IN ZINC ALLOY | CONCENTRATION | DISCHARGE TEST |
| | PARTICLE | (ppm) | (ppm) | IN ZINC ALLOY | (ml/day) |
| BATTERY 8 | 2.0 | 100 | 1000 | 10.0 | 0.41 |
| BATTERY 9 | 2.0 | 150 | 1000 | 6.7 | 0.22 |
| BATTERY 10 | 2.0 | 200 | 1000 | 5.0 | 0.16 |
| BATTERY 11 | 2.0 | 350 | 1000 | 2.9 | 0.21 |
| BATTERY 12 | 2.0 | 400 | 1000 | 2.5 | 0.38 |
| BATTERY 13 | 2.2 | 100 | 1000 | 10.0 | 0.39 |
| BATTERY 14 | 2.2 | 150 | 1000 | 6.7 | 0.22 |
| BATTERY 15 | 2.2 | 200 | 1000 | 5.0 | 0.10 |
| BATTERY 16 | 2.2 | 350 | 1000 | 2.9 | 0.19 |
| BATTERY 17 | 2.2 | 400 | 1000 | 2.5 | 0.37 |
| BATTERY 18 | 2.4 | 100 | 1000 | 10.0 | 0.43 |
| BATTERY 19 | 2.4 | 150 | 1000 | 6.7 | 0.22 |
| BATTERY 20 | 2.4 | 200 | 1000 | 5.0 | 0.12 |
| BATTERY 21 | 2.4 | 350 | 1000 | 2.9 | 0.22 |
| BATTERY 22 | 2.4 | 400 | 1000 | 2.5 | 0.40 |

The results showed that when the aspect ratio of a zinc particle ranges from 2.0 to 2.4, and the indium concentration in the zinc alloy is 1000 ppm, the bismuth concentration in the zinc alloy is related to the gas generation rate, and that when the bismuth concentration in the zinc alloy is 150-350 ppm, the gas generation rate is low. In contrast, the gas generation rate of each of Batteries 8, 13, and 18 in which the bismuth concentration is lower than 150 ppm is high. It was found that the gas generation rate of each of Batteries 12, 17, and 22 in which the bismuth concentration is higher than 350 ppm is high.

### (5) Indium Concentration in Zinc Alloy

Next, Batteries 23-37 were produced under conditions similar to the conditions where Battery 1 was produced except that as illustrated in Table 3, when the aspect ratio of a zinc particle ranges from 2.0 to 2.4, the indium concentration in the zinc alloy was varied. Table 3 illustrates results of charge-discharge tests.

TABLE 3

| | | | | INDIUM | GAS GENERATION |
|---|---|---|---|---|---|
| | | BISMUTH | INDIUM | CONCENTRATION/ | RATE AFTER |
| | ASPECT RATIO | CONCENTRATION | CONCENTRATION | BISMUTH | CHARGE/ |
| | OF ZINC ALLOY | IN ZINC ALLOY | IN ZINC ALLOY | CONCENTRATION | DISCHARGE TEST |
| | PARTICLE | (ppm) | (ppm) | IN ZINC ALLOY | (ml/day) |
| BATTERY 23 | 2.0 | 250 | 400 | 1.6 | 0.55 |
| BATTERY 24 | 2.0 | 250 | 600 | 2.4 | 0.24 |
| BATTERY 25 | 2.0 | 250 | 750 | 3.0 | 0.19 |
| BATTERY 26 | 2.0 | 250 | 1500 | 6.0 | 0.20 |
| BATTERY 27 | 2.0 | 250 | 2000 | 8.0 | 0.38 |
| BATTERY 28 | 2.2 | 250 | 400 | 1.6 | 0.51 |
| BATTERY 29 | 2.2 | 250 | 600 | 2.4 | 0.24 |
| BATTERY 30 | 2.2 | 250 | 750 | 3.0 | 0.11 |
| BATTERY 31 | 2.2 | 250 | 1500 | 6.0 | 0.12 |
| BATTERY 32 | 2.2 | 250 | 2000 | 8.0 | 0.40 |
| BATTERY 33 | 2.4 | 250 | 400 | 1.6 | 0.49 |
| BATTERY 34 | 2.4 | 250 | 600 | 2.4 | 0.24 |
| BATTERY 35 | 2.4 | 250 | 750 | 3.0 | 0.17 |
| BATTERY 36 | 2.4 | 250 | 1500 | 6.0 | 0.16 |
| BATTERY 37 | 2.4 | 250 | 2000 | 8.0 | 0.51 |

The results showed that when the aspect ratio of a zinc particle ranges from 2.0 to 2.4, and the bismuth concentration in the zinc alloy is 250 ppm, the indium concentration in the zinc alloy is related to the gas generation rate, and that when the indium concentration is 600-1500 ppm, the gas generation rate is low. In contrast, the gas generation rate of each of Batteries 23, 28, and 33 in which the indium concentration is lower than 600 ppm is high. It was found that the gas generation rate of each of Batteries 27, 32, and 37 in which the indium concentration is higher than 1500 ppm is high.

The aspect ratio of a zinc particle in each of batteries in which the bismuth concentration in the zinc alloy is 200 ppm, and the indium concentration therein is 1000 ppm was studied. The evaluation results are shown in Table 4.

TABLE 4

| | | | | INDIUM | GAS GENERATION |
|---|---|---|---|---|---|
| | | BISMUTH | INDIUM | CONCENTRATION/ | RATE AFTER |
| | ASPECT RATIO | CONCENTRATION | CONCENTRATION | BISMUTH | CHARGE/ |
| | OF ZINC ALLOY | IN ZINC ALLOY | IN ZINC ALLOY | CONCENTRATION | DISCHARGE TEST |
| | PARTICLE | (ppm) | (ppm) | IN ZINC ALLOY | (ml/day) |
| BATTERY 38 | 1.6 | 200 | 1000 | 5.0 | 0.38 |
| BATTERY 39 | 2.7 | 200 | 1000 | 5.0 | 0.46 |

The results of Tables 4 and 2 showed that when the aspect ratio of a zinc particle is out of the optimized range, i.e., when as in Batteries 1 and 38, the aspect ratio of a zinc particle is low, such as 1.6, or when as in Batteries 7 and 39, the aspect ratio of a zinc particle is high, such as 2.7, the gas generation rate is high even under conditions where the bismuth concentration and the indium concentration are within the corresponding optimized ranges.

The above results showed that in the alkaline secondary battery of the present invention, the aspect ratio of a zinc particle, the bismuth concentration, and the indium concentration are closely related to the gas generation rate after charge/discharge. Specifically, when all of them are within the corresponding optimized ranges, the gas generation rate is low; however, when any one of the aspect ratio, the bismuth concentration, and the indium concentration is out of the corresponding optimized range, the gas generation rate is higher than 0.25 ml/day, and electrolyte leakage is more likely to occur.

The reason why as such, the three factors affect the gas generation rate, and only when all of the factors are within the corresponding optimized ranges, better performance is provided can be considered as described below.

When in a charge/discharge process, zinc is significantly deformed, or when in the process, segregation of added elements, such as bismuth and indium, proceeds, the gas generation rate increases. When as in Batteries 7 and 39, the aspect ratio is too high, zinc is significantly deformed in the charge/discharge process, pulverization of zinc also proceeds, and segregation of added elements, such as bismuth and indium, proceeds; therefore, the gas generation rate increases. When as in Batteries 1 and 38, the aspect ratio is too low, this causes poor electrical contact in a charge/discharge process, and a reaction in an electrode becomes nonuniform. As a result, deformation of a portion of zinc and pulverization thereof proceed, and segregation of added elements, such as bismuth and indium, proceeds in the deformed and pulverized portion; therefore, the gas generation rate increases.

The reason why even when the aspect ratio of a zinc particle is within the optimized range, the gas generation rate increases unless the bismuth concentration and the indium concentration are within the corresponding optimized ranges is considered as described below.

When bismuth or indium is alloyed with zinc, bismuth or indium originally tends to exist at grain boundaries of the alloy. Thus, in the charge/discharge process, zinc is deformed as below. Zinc at the grain boundaries is preferentially dissolved, and thus, even when zinc is again deposited, zinc is segregated on the outer surfaces of particles rather than in particles or at the grain boundaries. However, when the ratio between bismuth and indium is specific, bismuth, indium, and zinc tend to be uniformly distributed, and bismuth and indium tend to exist relatively in particles; therefore, segregation in the charge/discharge process is less likely to occur.

The above tendency is seen also from the results of Tables 1-3 showing that the ratio between the indium concentration and the bismuth concentration is preferably within the range of 3-6, because in this case, the gas generation rate is low.

### (5) Proportion of Zinc Particles Having a Particle Size of 75 μm or Less

Next, Batteries 40-54 similar to Battery 1 were produced except that with various zinc particle aspect ratios and various zinc alloy compositions as illustrated in Table 5, the proportion of zinc alloy particles having a particle size of 75 μm or less was varied. The evaluation results are shown in Table 5.

TABLE 5

| | | BISMUTH | | INDIUM | PROPORTION OF | GAS GENERATION |
|---|---|---|---|---|---|---|
| | | CONCEN- | INDIUM | CONCENTRATION/ | 75-μm-OR-LESS | RATE AFTER |
| | ASPECT RATIO | TRATION | CONCENTRATION | BISMUTH | ZINC ALLOY | CHARGE/ |
| | OF ZINC ALLOY | IN ZINC ALLOY | IN ZINC ALLOY | CONCENTRATION | PARTICLES | DISCHARGE TEST |
| | PARTICLE | (ppm) | (ppm) | IN ZINC ALLOY | (% BY MASS) | (ml/day) |
| BATTERY 40 | 2.2 | 250 | 1000 | 4.0 | 1 | 0.21 |
| BATTERY 41 | 2.2 | 250 | 1000 | 4.0 | 5 | 0.14 |
| BATTERY 42 | 2.2 | 250 | 1000 | 4.0 | 10 | 0.13 |
| BATTERY 43 | 2.2 | 250 | 1000 | 4.0 | 18 | 0.18 |
| BATTERY 44 | 2.2 | 260 | 1000 | 4.0 | 25 | 0.27 |
| BATTERY 45 | 2.2 | 250 | 1500 | 6.0 | 1 | 0.24 |
| BATTERY 46 | 2.2 | 250 | 1500 | 6.0 | 5 | 0.17 |
| BATTERY 47 | 2.2 | 250 | 1500 | 6.0 | 10 | 0.15 |
| BATTERY 48 | 2.2 | 250 | 1500 | 6.0 | 18 | 0.18 |
| BATTERY 49 | 2.2 | 250 | 1500 | 6.0 | 25 | 0.24 |
| BATTERY 50 | 2.4 | 250 | 1500 | 6.0 | 1 | 0.23 |
| BATTERY 51 | 2.4 | 250 | 1500 | 6.0 | 5 | 0.19 |
| BATTERY 52 | 2.4 | 250 | 1500 | 6.0 | 10 | 0.17 |
| BATTERY 53 | 2.4 | 250 | 1500 | 6.0 | 18 | 0.19 |
| BATTERY 54 | 2.4 | 250 | 1500 | 6.0 | 25 | 0.25 |

The results showed that the proportion of the particles having a particle size of 75 μm or less is preferably 5-18%, because the gas generation rate after the charge-discharge test is low. The reason why the gas generation rates of Batteries 41-43, 46-48, and 51-53 are lower than when the proportion of the particles having a particle size of 75 μm or less is low as in Batteries 40, 45, and 50 is that since the amount of zinc microparticles serving as crystal nuclei in a charge process is optimized, and the amount of ultrafine zinc particles deposited from zinc acid ions dissolved in an electrolyte solution directly on zinc crystals decreases, the gas generation rate decreases.

In contrast, when the proportion of the particles having a particle size of 75 μm or less is high, the surface area of original microparticles is large; also after charge/discharge, the microparticles tend to be deformed; and a further increase in the surface area and segregation of added elements tend to proceed. Therefore, Batteries 41-43, 46-48, and 51-53 are appropriate, because the gas generation rates of these batteries are lower than those of Batteries 44, 49, and 54.

### INDUSTRIAL APPLICABILITY

The alkaline secondary battery according to the present invention is useful for alkaline secondary batteries with excellent leakage resistance.

### DESCRIPTION OF REFERENCE CHARACTERS

1 Battery Case
1a Positive Electrode Terminal
2 Positive Electrode
3 Gelled Negative Electrode
4 Separator
5 Gasket
5a Thin Portion
6 Negative Electrode Current Collector
7 Negative Electrode Terminal
8 Exterior Label
9 Sealing Unit

1. An alkaline secondary battery, comprising:
a gelled negative electrode containing zinc alloy powder, wherein
an aspect ratio of a particle of the zinc alloy powder is within a range of 2.0-2.4, and the zinc alloy contains 150-350 ppm of bismuth, and 600-1500 ppm of indium.

2. The alkaline secondary battery of claim 1, wherein
a positive electrode contains manganese dioxide.

3. The alkaline secondary battery of claim 1, wherein
a mass ratio of bismuth to indium in the zinc alloy is within a range of 1:3-1:6.

4. The alkaline secondary battery of claim 1, wherein
the zinc alloy powder contains particles having a particle size of 75 μm or less in a proportion of 5-18% by mass.
